(19) United States
(12) Patent Application Publication
(10) Pub. No.: US 2017/0249339 A1
(43) Pub. Date: Aug. 31, 2017

(54) SELECTED IMAGE SUBSET BASED SEARCH

(71) Applicant: SHUTTERSTOCK, INC., New York, NY (US)

(72) Inventor: Kevin Scott LESTER, Summit, NJ (US)

(21) Appl. No.: 15/054,025

(22) Filed: Feb. 25, 2016

(51) Int. Cl. G06F 17/30; G06F 3/0484; G06F 3/0482; G06K 9/66

(52) U.S. Cl. CPC G06F 17/30256; G06K 9/66; G06F 3/04842; G06F 3/0482; G06F 17/30274; G06F 17/30271

(57) ABSTRACT

Various aspects of the subject technology relate to systems, methods, and machine-readable media for selected image subset based search. The subject technology includes an image retrieval system using a convolutional neural network that is trained to identify features from pixel data and using an image search engine to search features of a cropped raw image against images having similar content. The system identifies a subset image corresponding to a user selection of a portion of an image. The system provides the subset image to a storage service to obtain a raw image. The system maps pixel data of the raw image corresponding to the selected portion of the image to create the cropped raw image, and fed through a feature extractor to form a corresponding feature vector. The feature vector of the cropped raw image may be searched against images having similar content to determine a prioritized listing of images.

### BACKGROUND

Field

The present disclosure generally relates to a computer-based neural network for image retrieval, and more particularly to selected image subset based search.

Description of the Related Art

Users commonly search for content, such as visual content items, and use the visual content items they find to produce a creative illustration. Such users can search for visual content items through a search interface for a media collection. Standard approaches for searching for visual content items include text-based image search and upload-based image search. In the text-based approach, an image search includes a search relying upon keywords parsed from a text-based user query. In the upload-based approach, an image search includes a search for content that closely resembles the content of a whole image in its entirety. However, image searches using text-based queries and/or whole image queries may return a wide array of content that does not specifically reflect a user's desired content at the time of the search.

### SUMMARY

The disclosed system provides for a reverse image search by providing a cropped image as a search query to a computer-operated neural network that is configured to analyze image pixel data of the cropped image in order to identify features of the cropped image that appear relevant to images containing content similar to that of the cropped image, and presenting those relevant images as responsive to the search query. The disclosed system includes an image retrieval system using the computer-operated neural network that is trained to identify features from pixel data and using an image search engine to search features of the cropped image against an image collection having similar content. The disclosed system receives an input image, and can identify a subset image corresponding to a user selection of a portion of the input image. The disclosed system provides the subset image to a storage service to retrieve an appropriately sized raw image. The disclosed system can map pixel data of the retrieved raw image corresponding to the selected portion of the image to create the cropped image, and feed through a feature extractor to form a corresponding feature vector of the cropped image. The feature vector of the cropped image may be searched against images of the image collection having similar content to determine a prioritized listing of images. In certain aspects, the computer-operated neural network is trained using a set of training images and text as training data, and extracts features from the set of training images as a part of the training process. The neural network may maintain a matrix of probabilities of each feature vector to words, which may be used for keyword prediction as part of the reverse image search.

According to one embodiment of the present disclosure, a computer-implemented method is provided for retrieving a set of images identified as responsive to a cropped image serving as an image search query from a user based on features of the cropped image identified as relevant to images having similar content. The method includes receiving user input identifying a selection of at least a portion of a first image. The method also includes determining display coordinates of the selected at least a portion of the first image relative to display coordinates of the first image. The method also includes obtaining a second image based on the selection, in which the second image is a raw image version of the first image. The method also includes generating a cropped image corresponding to at least a portion of the second image based on the determined display coordinates. The method also includes initiating a reverse image search using the cropped image, and generating search results associated with the reverse image search based on a comparison between the cropped image and a collection of images.

According to one embodiment of the present disclosure, a system is provided including one or more processors and a computer-readable storage medium coupled to the one or more processors, in which the computer-readable storage medium includes instructions that, when executed by the one or more processors, cause the one or more processors to receive a first user input comprising image data. The instructions may cause the one or more processors to provide a representation of the image data for display. In this regard, the instructions cause the one or more processors to receive a second user input comprising a user selection with respect to the displayed representation of the image data, in which the user selection identifies a first selected image subset of the image data. The first selected image subset may represent a search query for initiating an image search. The instructions may cause the one or more processors to determine a collection of images relevant to one or more features of the image data, and compare feature vectors of images in the collection of images to a feature vector of the first selected image subset. The instructions may cause the one or more processors to generate search results associated with the image search based on comparison results of the comparison between the feature vector of the first selected image subset and the feature vectors of the images.

According to one embodiment of the present disclosure, a non-transitory computer readable storage medium including instructions is provided that, when executed by a processor, cause the processor to provide a user interface for display via an application of a client device. The instructions may cause the processor to receive a first user input comprising first image data, in which the first image data identifies a representation of one or more objects. The instructions may cause the processor to provide a representation of the first image data for display in an input section of the user interface. In this regard, the instructions may cause the processor to receive a second user input comprising a user selection associated with the displayed representation of the first image data, in which the user selection identifies selection of at least a portion of the displayed representation of the first image data within a two-dimensional bounding box. The instructions may cause the processor to determine coordinates of the two-dimensional bounding box relative to the displayed representation of the first image data. The instructions may cause the processor to provide a request to a storage service for second image data, in which the request identifies the user selection. The instructions may cause the processor to receive second image data from the storage service based on the user selection, in which the second image data is a raw image version of the first image data. The instructions may cause the processor to generate a first selected image subset of the second image data based on the determined coordinates, in which the first selected image subset corresponds to the selection of the at least a portion of the displayed representation of the first image data, and the first selected image subset represents a search query for initiating an image search. The instructions may cause the processor to provide a representation of the first selected image subset for display in the input section. The instructions may cause the processor to extract a feature vector of the first selected image subset. The instructions may cause the processor to compare feature vectors of one or more images in a collection of images to the feature vector of the first selected image subset. The instructions may cause the processor to generate search results associated with the image search based on comparison results of the comparison between the feature vector of the first selected image subset and the feature vectors of the one or more images. The instructions may cause the processor to provide for display the search results in an output section of the user interface.

According to one embodiment of the present disclosure, a system is provided for retrieving a set of images identified as responsive to a cropped image serving as an image search query from a user based on features of the cropped image identified as relevant to images having similar content. The system includes means for receiving user input identifying a selection of at least a portion of a first image. The system also includes means for determining display coordinates of the selected at least a portion of the first image relative to display coordinates of the first image. The system also includes means for obtaining a second image based on the selection, in which the second image is a raw version of the first image. The system also includes means for generating a cropped image corresponding to at least a portion of the second image based on the determined display coordinates. The system also includes means for initiating a reverse image search using the cropped image, and means for generating search results associated with the reverse image search based on a comparison between the cropped image and a collection of images.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the images and detailed description are to be regarded as illustrative in nature and not as restrictive.

### BRIEF DESCRIPTION OF THE IMAGES

The accompanying images, which are included to provide further understanding and are incorporated in and constitute a part of this specification, illustrate disclosed embodiments and together with the description serve to explain the principles of the disclosed embodiments. In the images:

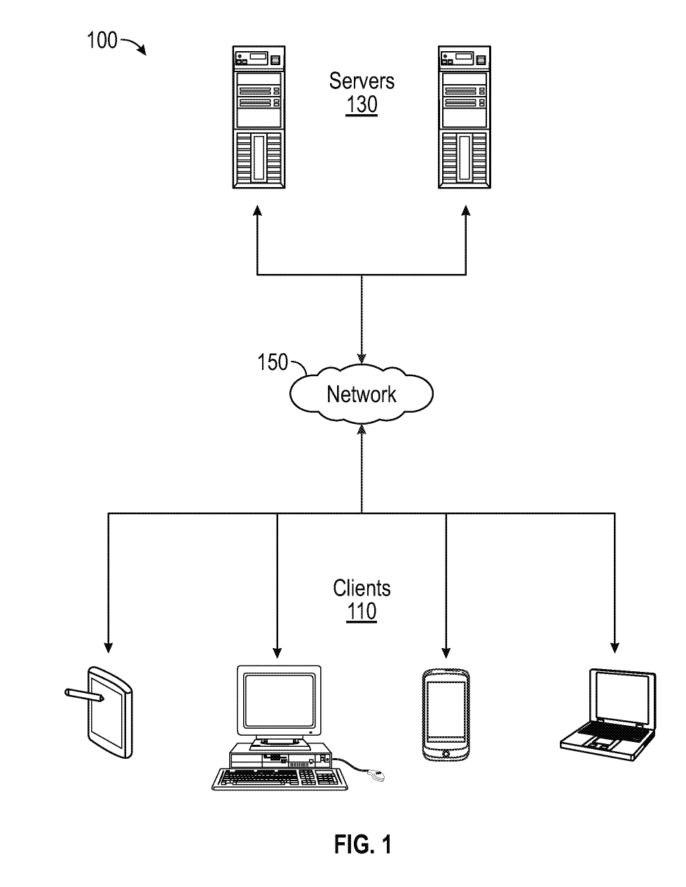

FIG. 1 illustrates an example architecture for a selected image subset based search system suitable for practicing some implementations of the subject technology.

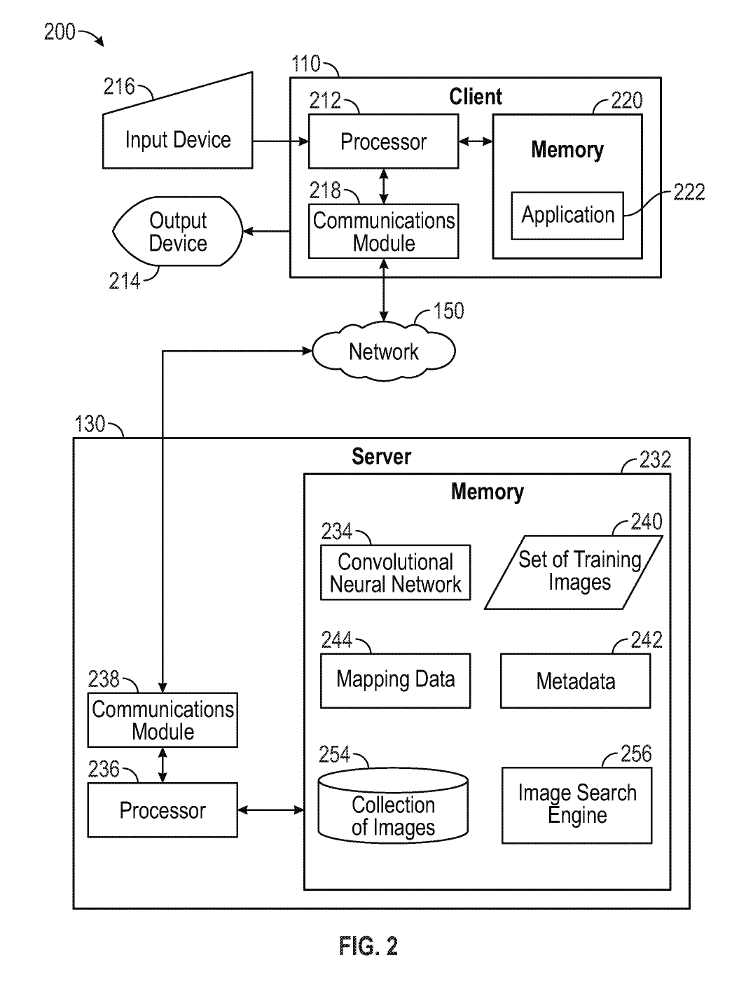

FIG. 2 is a block diagram illustrating an example client and server from the architecture of FIG. 1 according to certain aspects of the disclosure.

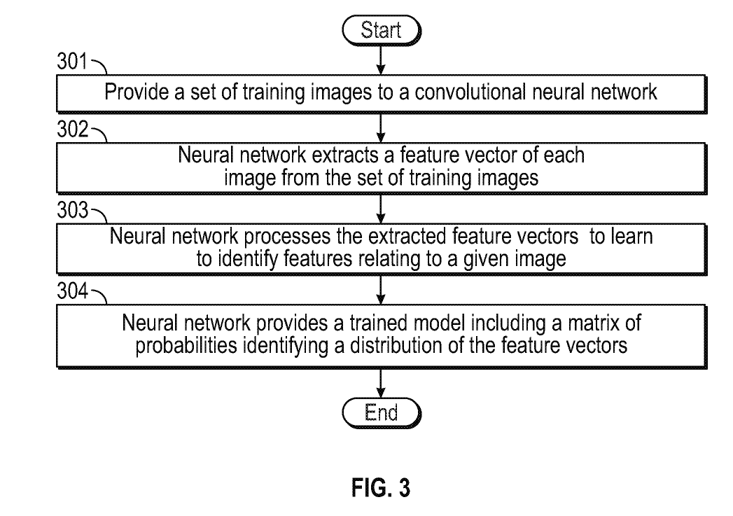

FIG. 3 illustrates an example process for training a convolutional neural network to analyze image pixel data to identify features in example images using the example server of FIG. 2.

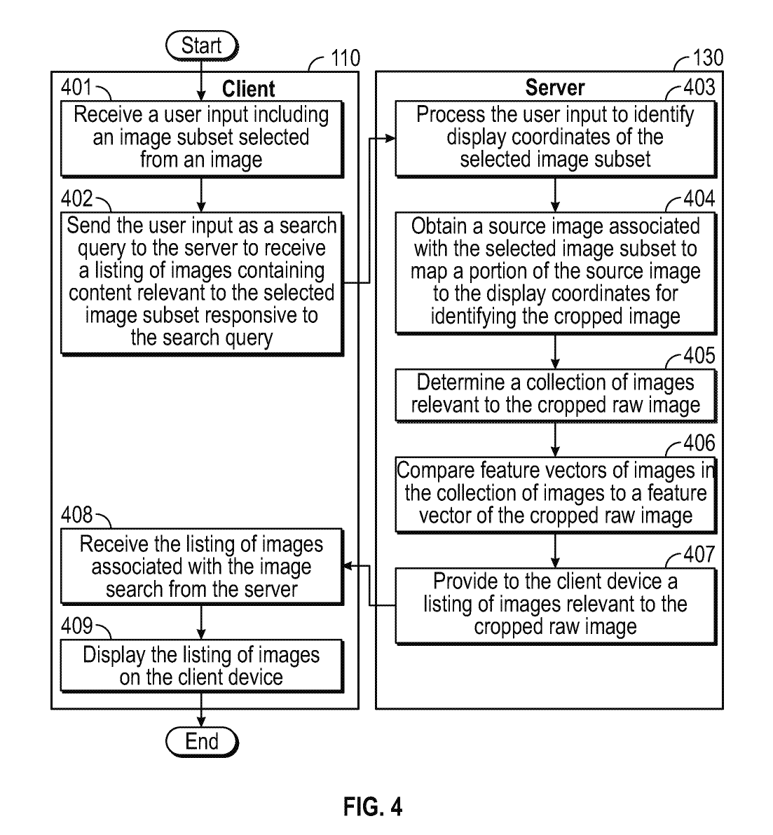

FIG. 4 illustrates an example process for selected image subset based search using the example client and server of FIG. 2.

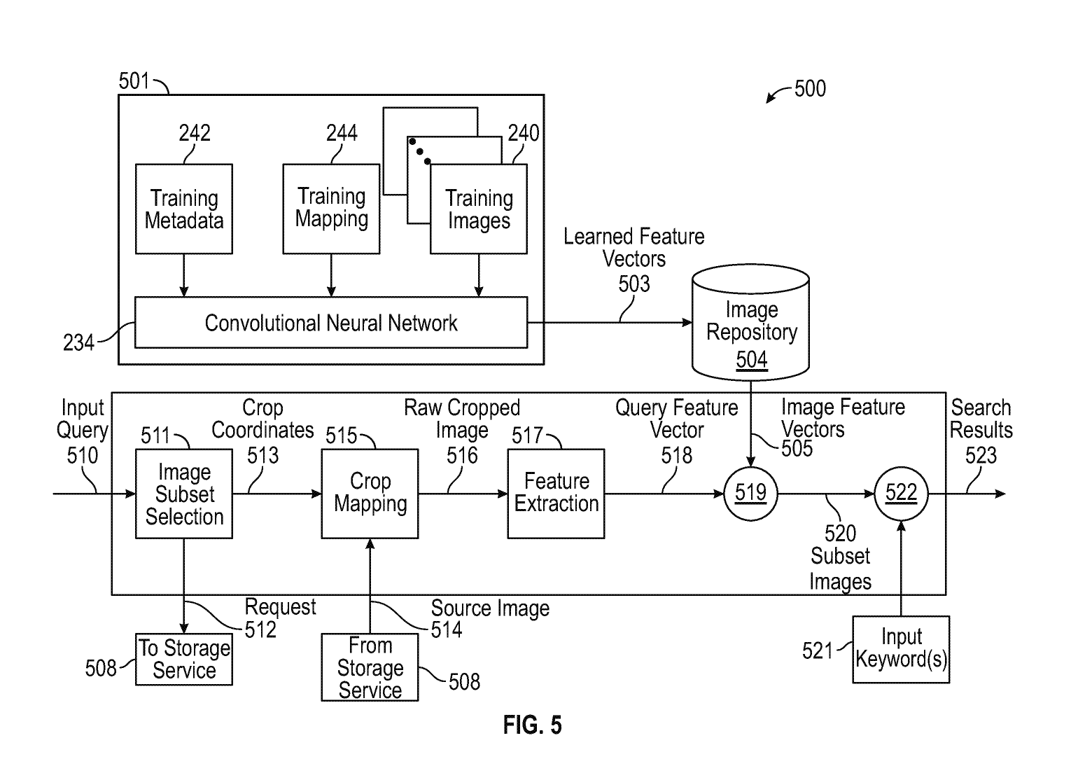

FIG. 5 illustrates a schematic diagram of an example architecture suitable for practicing the example process of FIG. 4.

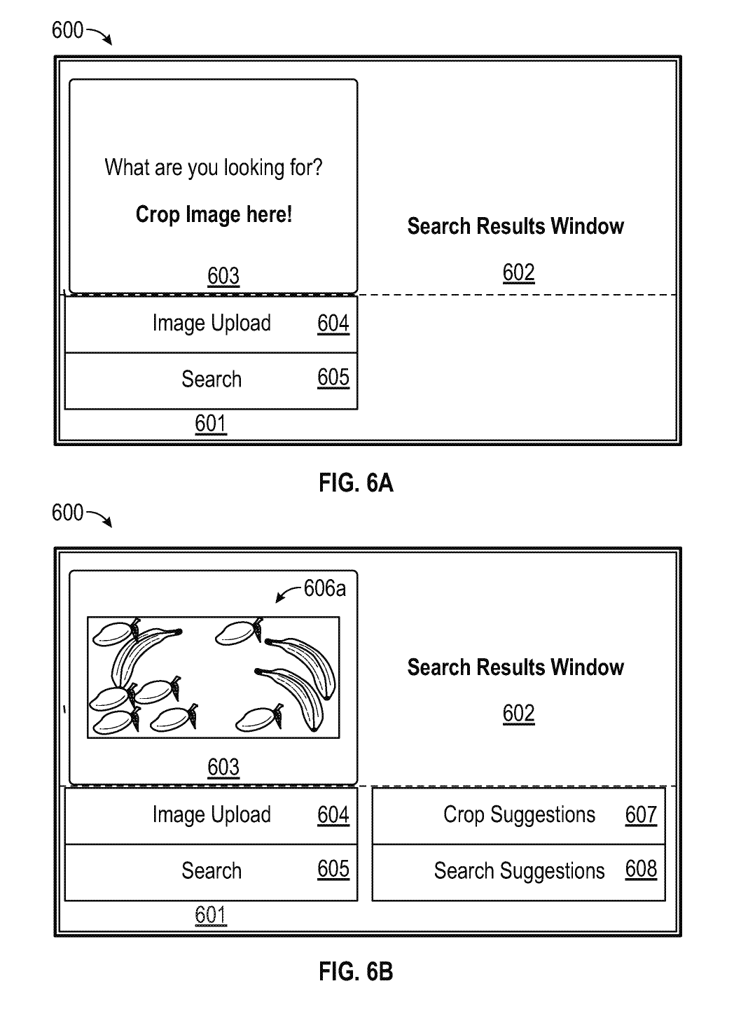

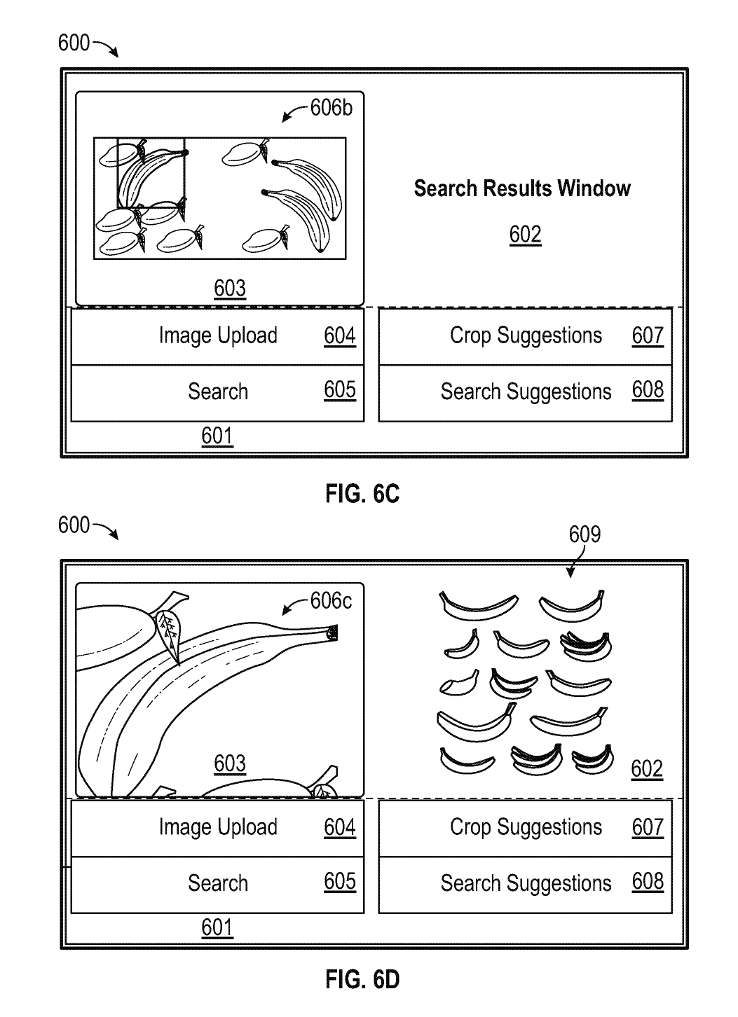

FIGS. 6A-6D illustrate examples of a display including a user interface for selected image subset based search according to certain aspects of the subject technology.

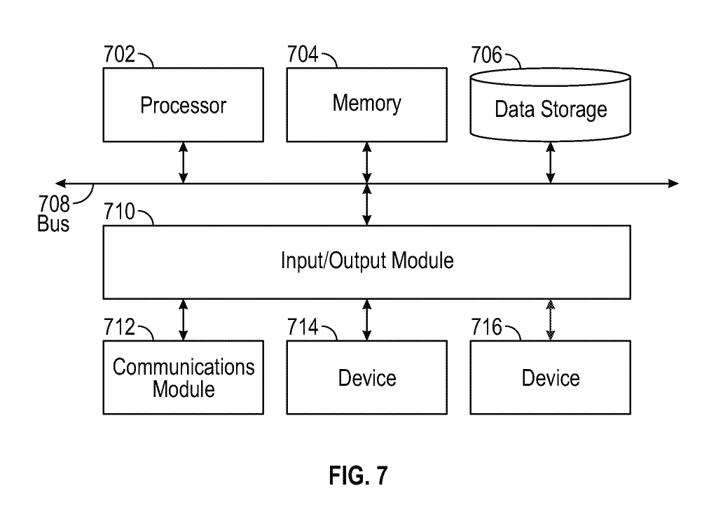

FIG. 7 is a block diagram illustrating an example computer system with which the client and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

There is a problem with current image search engines in that users rely upon text-based image search and upload-based image search when searching for visual content through a media collection. In the text-based approach, the image search initiates a search by parsing keywords from the text-based user query that will drive the search. However, a text entry may identify an image corresponding to a meaning different than what the user originally intended. In the upload-based approach, the image search initiates a search for visual content that closely resembles an image uploaded by a user. However, the image may contain multiple objects that may influence the search to yield a wide array of result images of varying content. Such variety in results may be burdensome for the user to sort through thereby adversely impacting the user experience. In addition, current image search engines that receive an image with watermark information (or security information) may be constrained to the security features and/or settings of the received image, thereby limiting the breadth of the image search. Consequently, image searches relying on text-based queries and/or uploaded-image queries using images with watermark information may not accurately identify the most relevant visual content.

The disclosed system addresses this problem specifically arising in the realm of computer technology by providing a solution also rooted in computer technology, namely, by the training of a computer-operated neural network, such as a convolutional neural network, to teach the neural network to identify features in images that would appear to contain representations of both foreground and background objects. In this respect, the disclosed system can accept a selected image subset (or cropped raw image) as an input query to search against images containing content that is visually similar to content of the cropped raw image. In certain aspects, the convolutional neural network is operated on a server and accesses large amounts of image data stored in memory of the server or stored elsewhere and accessible by the server in order to train the convolutional neural network. For example, a set of training images and text may be provided to the convolutional neural network as training data in order to teach the convolutional neural network how to identify features of images. Next, after the convolutional neural network has learned to identify features in images, the neural network creates a matrix of probabilities of each feature vector mapped to a corresponding word so that the neural network can predict which keyword corresponds to the identified features of an image.

The proposed solution further provides improvements to the functioning of the computer itself because it saves data storage space and reduces network usage. Specifically, the computer hosting the collection of images to be searched is not required to maintain in data storage or repeatedly share over a network with the convolutional neural network classification information based on the trained semantic concepts for the images to be searched because the convolutional neural network, once trained, is configured to predict which features of the images correlated to content of a selected image subset without this information.

As used herein, the term “semantic concept” refers to the meaning used for understanding an object and/or environment of things. The term “visual word” as used herein refers to a particular meaning of a language word derived from its visual expression. The term “semantic concept” can be interchangeably used with the term “visual word” which captures the semantic space of a thing, and may be the target of an image search query.

FIG. 1 illustrates an example architecture 100 for providing a set of images identified as responsive to a selected image subset based search query from a user based on features of a cropped raw image represented as the image search query. The architecture 100 includes servers 130 and clients 110 connected over a network 150.

One of the many servers 130 is configured to host a computer-operated neural network. The neural network, which can be a convolutional neural network, is trained to identify features in images containing representations of one or more objects such as foreground objects and background objects. One or more of the many servers 130 also hosts a collection of images. The collection of images can be searched using an image search engine (e.g., accessible through a web page on one of the clients 110). Images from the collection can also be used to train the neural network to identify features of the images and, with the addition of metadata identifying relationships between the images and corresponding visual words, once identified, are likely to indicate that the corresponding image is more likely to be relevant to content identified by a cropped raw image serving as the image search query. For purposes of load balancing, multiple servers 130 can host the neural network and multiple servers 130 can host the collection of images.

The servers 130 can be any device having an appropriate processor, memory, and communications capability for hosting the neural network, the collection of images, and the image search engine. The image search engine is accessible by various clients 110 over the network 150. The clients 110 can be, for example, desktop computers, mobile computers, tablet computers (e.g., including e-book readers), mobile devices (e.g., a smartphone or PDA), or any other devices having appropriate processor, memory, and communications capabilities for accessing the image search engine on one of the servers 130. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The server 130 includes a processor 236, a communications module 238, and a memory 232. The memory 232 of the server 130 includes a convolutional neural network 234. As discussed herein, a convolutional neural network 234 is a type of feed-forward artificial neural network where individual neurons are tiled in such a way that the individual neurons respond to overlapping regions in a visual field. The convolutional neural network 234 can be, for example, AlexNet, GoogLeNet, or a Visual Geometry Group convolutional neural network. In certain aspects, the convolutional neural network 234 consists of a stack of convolutional layers followed by several fully connected layers. The convolutional neural network 234 can include a loss layer (e.g., softmax or hinge loss layer) to back propagate errors so that the convolutional neural network 234 learns and adjusts its weights to better fit provided image data.

The memory 232 also includes a collection of images 254 and an image search engine 256 for searching the collection of images 254. The classes can correspond to visual words (e.g., dog, boat, hammer, bridge, etc.). In some aspects, an object may correspond to a visual word, and different objects may correspond to respective visual words. In this respect, an image having a representation of multiple objects may be associated with multiple visual words.

The collection of images 254 can be, for example, a dataset of images consisting of a predetermined number of classes (e.g., 10,000) with image vector information and image cluster information. The image vector information identifies vectors representing a large sample of images (e.g., about 50 million) and the image cluster information identifies the vectors in one or more clusters representing respective visual words such that each of the cluster of images represents a visual word. Although the collection of images 254 and the image search engine 256 are illustrated as being in the same memory 232 of a server 130 as the convolutional neural network 234, in certain aspects the collection of images 254 and the image search engine 256 can be hosted in a memory of a different server but accessible by the server 130 illustrated in FIG. 2.

The processor 236 of the server 130 is configured to execute instructions, such as instructions physically coded into the processor 236, instructions received from software in memory 232, or a combination of both. In certain aspects, the processor 236 of the server 130 is configured to receive a user input from a user. A processor of the client 110 is configured to transmit the user input over the network 150 using the communications module 218 of the client 110 to the communications module 238 of the server 130. The user input includes input image data identifying a representation of an object or scene. The user input is received, for example, by the user accessing the image search engine 256 over the network 150 using an application 222 in memory 220 on a client 110 of the user, and the user submitting the user input using an input device 216 of the client 110. For example, the user may use the input device 216 to upload the input image data to the server 130. The user, at the client 110, may be prompted to select a portion of the input image data using the application 222 to create a selected image subset. The selected image subset may include content identifying a representation of a selected object. In many aspects, the input image data includes watermark information as a security feature of the input image data. The processor 236 may then access a data source to obtain an appropriately sized version of the input image data without the watermark information (e.g., a source image). For example, the processor 236 may obtain a smallest sized version of the input image data that provides sufficient image information such that the data loss is minimal when generating a 256×256 thumbnail version of the obtained image data. The appropriately sized source image (without the watermark) may be cropped based on display coordinates of the selected image subset. In this respect, the cropped raw image serves as the search query (e.g., input to the image search engine 256) for the collection of images 254. In one or more implementations, the search query includes the selected image subset and an image identifier associated with the source image.

The processor 236 of the server 130, upon receiving the search query for the image search engine 256, is configured to submit a search request for the search query to the image search engine 256. The processor 236 then receives an identification of a plurality of images, from the collection of images 254 that are responsive to the search query, and is configured to provide a listing of the plurality of images with a ranking according to a vector distance relative to a feature vector of the cropped raw image. In one or more embodiments, the feature vectors are precomputed for all images and stored in an index (e.g., the collection of images 254). In this respect, when the cropped raw image is received by the server 130, the processor 136, using the neural network 234, extracts the feature vector of the cropped raw image, and compares the cropped image feature vector to each of the precomputed feature vectors in the collection of images 254 to return the listing of the plurality of images. The listing of the plurality of images that is prioritized (or ranked) according to the vector distance relative to a feature vector of the cropped raw image is provided, for example, by the processor 236 of the server 130 being configured to submit the plurality of images that are responsive to the search query to the convolutional neural network 234, and the convolutional neural network 234 identifying images having content with similar features to those features of the cropped raw image. The processor 236 may then prioritize the listing of the plurality of images according to the vector distances, and provide the listing to the application 222 on the client 110 over the network 150 for display by an output device 214 of the client 110.

In certain aspects, the processor 236 is configured to determine a collection of images that is relevant to one or more visual words associated with the cropped raw image. The processor 236 may determine that a subset of the collection of images is associated with the visual words thereby alleviating the amount of image data to process during the image search. In this respect, the processor 236 may call the image search engine 256 to search against images that have similar content. In one aspect, the subset of images associated with the visual words are identified by mapping data identifying relationships between each of the collection of images and one or more visual words (e.g., mapping data 244). For example, an image depicting a sandy coastline may be associated with one or more visual words (e.g., beach, ocean, etc.).

In one or more aspects, the processor 236 of the server 130 is configured to compare feature vectors of images in the collection of images to a feature vector of the cropped raw image. The images may have their features extracted in advance (e.g., prior to receipt of any image search query) such that the feature vectors of the images are part of the collection of images 254. In some implementations, the feature vectors of the images may be stored in a separate data structure than the repository containing the collection of images 254. In one or more implementations, the feature vectors of the images are extracted in response to user input containing an image search query. In this implementation, the images associated with similar visual words may be submitted to a feature extractor to obtain features of the images which can then be mapped to one or more elements of corresponding feature vectors. Similarly, the cropped raw image may be submitted to the feature extractor to obtain features of the cropped raw image that are then mapped onto a feature vector for comparison to the feature vectors of the images. The feature extractor, for example, may be a part of the convolutional neural network 234 depending on implementation. In other examples, the feature extractor may be separate from the convolutional neural network 234 and operably coupled to the convolutional neural network 234.

In comparing the feature vectors of the images to the feature vector of the cropped raw image, the processor 236 may determine a vector difference between the feature vector of the cropped raw image and each of the feature vectors of the images. In some aspects, the image search engine 256 may determine the angle difference (e.g., cosine distance) between the vectors. In this respect, the processor 236 selects one or more of the feature vectors having the smallest cosine distance relative to the feature vector of the cropped raw image. In other aspects, the processor 236 determines a distance between the vectors, and then compares each of the vector distances to a predetermined threshold to determine whether one or more of the compared vector distances satisfies the predetermined threshold.

In some aspects, the processor 236 of the server 130 is configured to generate search results associated with the image search based on comparison results of the comparison between the feature vector of the cropped raw image and the feature vectors of the images. For example, the processor 236 may generate the search results by obtaining images of the collection of images which correspond to the selected one or more feature vectors of the images (e.g., images having the smallest cosine distance relative to the cropped raw image). The processor 236 may prioritize the search results based on the cosine distance between the feature vector of the cropped raw image and the feature vectors of the images. In some examples, the search results may include a listing of images in ascending order (e.g., image with the smallest cosine distance is listed at the top or start of listing). In certain aspects, the processor 236 may filter the search results based on different types of metadata (e.g., keywords) and/or weighted contributors (e.g., usage behavior, geography, time-of-day, etc.). In this respect, the search results include a listing of images containing content that closely resemble the cropped raw image.

The memory 232 of the server 130 also includes a set of training images 240. The set of training images 240 can be, for example, a dataset of images consisting of a predetermined number of classes (e.g., about 10,000) with a predetermined number of images per class. The set of training images 240 may include vector information and cluster information, in which the vector information identifies training vectors representing a large sample of training images and the cluster information identifies clusters representing respective visual words. In this respect, the vectors corresponding to a common visual word are clustered into one cluster. Although the set of training images 240 is illustrated as being separate from the collection of images 254, in certain aspects the set of training images 240 is a subset of the collection of images 254.

In one or more embodiments, the operations relating to the training of the convolutional neural network 234 are performed independent of the operations relating to the processing of the user input and/or the search query such that operations relating to the neural network training may be performed offline and prior to the user input and/or the search query being received. In some aspects, the neural network training takes place offline via another server (not shown) communicably coupled to the server 130 via the communications module 238. The processor 236 of the server 130 executes instructions to submit a plurality of training images (e.g., set of training images 240) and visual word information (e.g., metadata 242) to the convolutional neural network 234 that is configured to analyze image pixel data for each of the plurality of training images to identify features, in each of the plurality of training images, corresponding to one or more respective visual words and receive, from the neural network 234 and for each of the plurality of training images, a probability of likelihood that the training image includes content identifying one or more objects.

FIG. 3 illustrates an example process 300 for training a convolutional neural network to analyze image pixel data to identify features in example cropped raw images using the example server of FIG. 2. While FIG. 3 is described with reference to FIG. 2, it should be noted that the process steps of FIG. 3 may be performed by other systems.

The process 300 begins by proceeding from beginning step to step 301 when a set of training images 240 are provided to a convolutional neural network 234. For example, the convolutional neural network 234 can consist of a stack of eight layers with weights, the first five layers being convolutional layers and the remaining three layers being fully-connected layers. The set of training images 240 can be fixed-size 256×256 pixel Black-White image data or Red-Green-Blue (RGB) image data and feeding the training images through the convolutional neural network 234. In other aspects, the set of training images 240 can be fixed-size greater than 256×256 pixels.

Next, in step 302, the convolutional neural network 234 processes the set of training images 240 by extracting feature vectors of each image from the set of training images 240. The convolutional neural network 234 is configured to learn to identify features from image data representing multiple objects by analyzing pixel data of the image data. Training with the set of training images 240 may be regularized by weight decay and dropout regularization for the first two fully-connected layers with a dropout ratio set to 0.5, and the learning rate may initially be set to 10⁻² and then decreased by a factor of 10 when validation set accuracy stops improving for the convolutional neural network 234.

The metadata 242 may be provided to the convolutional neural network 234. The metadata 242 may include a listing of visual words which correspond to identifying objects or scenes. The processor 236 may be configured to submit a portion of the metadata to the convolutional neural network 234 when a corresponding training image or set of training images is fed to the convolutional neural network 234 for correlating the fed training images to the visual word identified in the portion of the metadata 242. In one or more aspects, portions of the metadata 242 may be indexed based on the training image and/or set of training images fed to the convolutional neural network 234 to identify the visual word corresponding to the index.

The mapping data 244 may be provided to the convolutional neural network 234. The mapping data 244 may relationships between the set of training images 240 and the visual words identified by the metadata 242. For example, the mapping data 244 may include predetermined mapping information which identifies a mapping between a first visual word and first feature information representing an object or scene. The convolutional neural network 234 may use this mapping information to understand a correlation between a set of extracted features and visual word for identifying an object or scene in at least a portion of the image. The mapping information can include additional mappings between a cluster of training images and a corresponding visual word such that content of the training images are indexed by a corresponding cluster identifier.

Next, in step 303, the convolutional neural network 234 processes the extracted feature vectors in order to learn to identify features relating to a given image. The extracted features may be then fed into a multinomial logistic regression to map them to their respective visual word (e.g., from the metadata 242 and the mapping data 244). In other aspects, the features extracted using the model generated by the convolutional neural network 234 as trained in step 304 is implemented with three fully connected layers of the convolutional neural network 234. As a result, at step 304, the convolutional neural network 234 provides a trained model specialized to understand and identify features of, or at least in part of, images. In one or more embodiments, the trained model is provided with a matrix of probabilities that identifies a distribution of the feature vectors with respect to one or more words (or keywords). The matrix of probabilities includes a probability value, for each feature vector, that a respective feature vector represents a given word. In many aspects, the trained model may be used to extract features of the cropped raw image via a forward pass of the convolutional neural network 234. The process 300 ends by terminating at the ending step.

In one or more embodiments, the trained model is used to identify objects, generate metadata associated with the identified objects, and provide predictive analyses. The trained model may generate metadata identifying objects in an image as part of an object recognition process. The metadata may include identifiers corresponding to respective portions of the processed image. In some aspects, the trained model predicts keywords for a corresponding image by predicting what content is identifiable within a selectable subset of the image. The keywords may be associated with respective visual words for the trained model to map extracted features of a selected image subset to the corresponding keywords.

FIG. 4 illustrates an example process 400 for selected image subset based search using the example client and server of FIG. 2. The process 400 begins in step 401 when a user, for example, loads an application 222 on a client 110 and the client 110 receives an input from the user using the input device 216 for a search query for a collection of images 254. The input includes an input image for initiating a reverse image search. The input image identifies a representation of one or more objects or scenes for selection as an image subset. The user can utilize the input device 216 to upload the input image and/or to provide a user selection identifying the image subset via a user interface of the application 222.

Next, in step 402, the application 222 on the client 110 sends the user input to the server 130 in order to receive a listing of images responsive to the search query, particularly images containing content relevant to the selected image subset. Turning to the server 130, in step 403, the server 130 receives the user input for the search query for a collection of images from the client 110. The server 130 processes the user input to identify coordinates of the selected image subset. In many aspects, the input image includes watermark information (or security features) for encrypting and/or restricting access to the raw data of the input image.

Subsequently, in step 404, the server 130 submits a request to a back-end storage service to obtain a source image associated with the selected image subset. The server 130 may use an identifier associated with the input image to perform a lookup operation from the back-end storage service. The source image may be a raw data version of the input image (e.g., without the watermark information) for cropping out the selected image subset. The server 130 may crop out a portion of the source image to create a cropped raw image by mapping the raw data of the source image that corresponds to the identified coordinates. In certain aspects, the server 130 obtains the best scaled size version of the source image since the greater number of raw bits available for processing the source image can increase the likelihood that the image search engine 256 performs a more accurate reverse image search.

Next, in step 405, the server 130 submits a search request with an indication of the selected image subset for the search query to an image search engine 256 for the collection of images 254. In some aspects, the server 130 includes an indication of one or more visual words associated with the selected image subset. An identification of a plurality of images from the collection of images 254 that are responsive to the search query is received from the image search engine 256. The identified images may represent a subset of the overall number of images in the collection of images 254, thereby alleviating the image search burden by reducing the volume of images to search against.

In step 406, the plurality of images are submitted to a computer-operated convolutional neural network 234 that is configured to analyze pixel data for each of the plurality of images to identify features in each of the plurality of images for comparison against features of the cropped raw image. In certain aspects, the features of each image in the collection of images 254 are extracted in an offline process, and the extracted features are stored in the collection of images 254. In some implementations, the image search engine 256 accesses the extracted features from the collection of images 254 in response to receiving the search request.

In some aspects, the cropped raw image may be submitted to the convolutional neural network 234 to extract a feature vector. In some aspects, the client 110 extracts a feature vector of the selected image subset, and sends the extracted feature vector to the server 130 as part of the input from the user. The server 130 can compare the feature vectors of the subset of images to the feature vector of the cropped raw image. The comparison can yield comparison results identifying a prioritized listing of angle differences between the feature vector of the cropped raw image and the feature vector of each compared image.

Subsequently, in step 407 the server 130 provides the client 110 with a listing of the plurality of images that is prioritized (or ranked) according to the prioritization of angle differences between the compared vectors. In some aspects, the user input from the client 110 includes one or more keywords to bound the search results within a search space associated with the cropped raw image and the keywords. In these aspects, the input keywords may be compared against metadata and/or a source identifier of each compared image. In other aspects, metadata of the input image uploaded to the server 130 may be used to refine the search results. For example, keywords associated with the input image may balance the search results toward more relevant content by filtering the number of images in the search results. In this respect, the keywords provide an additional layering of refinement to the search results, thereby focusing the search results to content desired by the user. Turning to the client 110, in step 408, the client 110 receives the listing of the plurality of images associated with the image search from the server 130. Next, in step 409, the listing of the plurality of images is provided for display via the application 222 of the client 110.

FIG. 5 illustrates a schematic diagram of an example architecture 500 suitable for practicing the example process of FIG. 4. The architecture 500 illustrates the process of FIG. 4 as a two-part process, where a first part 501 relates to the training process of the convolutional neural network 234, and a second part 502 relates to the processing of the user input for the reverse image search. In this respect, the architecture 500 provides for a selected image subset based input search query to search for images containing content with similar visual features to the selected image subset. In one or more embodiments, the operations relating to the first part 501 are performed independent of the operations relating to the second part 502 such that operations in the first part 501 may be performed offline in advance.

In the first part 501, the processor 236 of the server 130 may submit a plurality of training images (e.g., 240) to the convolutional neural network 234 that is configured to analyze pixel data for each of the plurality of training images to identify features in each of the plurality of training images. The processor 236 also may submit training metadata (e.g., 242) and/or training mapping data (e.g., 244) to the convolutional neural network 234 as part of the training process. As discussed in FIG. 3, the training metadata may be used to identify visual words to the convolutional neural network 234 and the training mapping data may be used to identify relationships between the training images and the visual words. The convolutional neural network processes the different types of training data to learn to identify features in the images that represent one or more objects. In turn, the convolutional neural network 234 outputs learned feature vectors 503 based on the training process. For example, the convolutional neural network 234 may extract feature descriptors of each training image, and map the descriptors to respective elements of a feature vector. The learned feature vectors 503 may be stored separately from image repository 504 or as part of the image repository 504.

In some aspects, the convolutional neural network 234 may store indexes identifying respective locations of the learned feature vectors 503 in the image repository 504. In one or more implementations, the learned feature vectors 503 may be stored with the corresponding training image. In these implementations, the image repository 504 may include association data identifying an association between the learned feature vector and the corresponding training image. The corresponding training image may be stored in the same location as the learned feature vector, or in a different location of the image repository 504.

In the second part 502, the processor 236 of the server 130 is configured to receive an input query 510 from a user. In these aspects, the input query 510 includes an input image identifying a representation of one or more objects. The input image may be provided for display on a display unit of the client 110. The input query 510 is fed to an image subset selection module 511 to allow the user to submit a user selection based on the displayed input image. The user selection may identify a two-dimensional bounding box representing what portion of the input image the user would like to crop out from the input image (e.g., the selected image subset). The bounding box may be a user interface for selecting a portion of the input image such that content within the bounding box is extracted from the input image. The bounding box may have a minimum size of 256×256 pixels and adjustable along the two dimensions (e.g., x-axis, y-axis) up to the size of the displayed image. In some aspects, the bounding box may be an overlay layer which overlaps the displayed input image.

Upon determining the selected image subset, the processor 236 sends an indication of the selected image subset in a request 512 to a storage service 508. The storage service 508 may store the raw bit information of the original image from which the selected image subset originates. In response to the request, the storage service 508 provides a source image 514. The source image 514 may represent the original image in raw form (e.g., without watermark information or encoded security information). The image subset selection 511 also may determine coordinates of the selected image subset relative to the dimensions of the input image for identifying cropping coordinates 513. Upon receipt of the source image 514, a crop mapping module 515 uses the cropping coordinates 513 to map the pixel data of the source image 514 which corresponds to the cropping coordinates 513 for creating a cropped raw image 516. In this example, the cropped raw image 516 includes content identified by the bounding box.

The cropped raw image 516 is submitted to a feature extraction module 517 to extract feature descriptors of the cropped raw image 516 which are then mapped into a query feature vector 518. The feature extraction module 517, for example, may be a part of the convolutional neural network 234 depending on implementation. In other examples, the feature extraction module 517 may be separate from the convolutional neural network 234 and operably coupled to the convolutional neural network 234.

The processor 236, upon receiving the query feature vector 518, is configured to submit a search request for a search query to the image search engine 256. The processor 236 then receives an identification of multiple images from the collection of images 254 that are responsive to the search query. The identification of the images may include the image feature vectors 505 for comparison to the query feature vector 518 at element 519. In this embodiment, the query feature vector 518 is compared against the image feature vectors 505 to identify a subset listing of images 520 containing content with similar features to those of the cropped raw image.

The processor 236 provides search results 523 with a ranking according to a prioritization of angle differences between the compared vectors. The processor 236 may provide the ranked search results 523 to the application 222 on the client 110 over the network 150 for display by an output device 214 of the client 110. In some aspects, the processor 236 further refines the subset listing of images 520 by accepting user input identifying one or more keyword entries 521. The keyword entries 521 may be a part of the input query 510, or received as a separate input from the client 110 depending on implementation.

In one embodiment, the processor 236 receives user input for modifying properties of the selected image subset. In these aspects, the user input may include a control to modify color properties of the selected image subset. For example, the user may desire to alter the original color of an object depicted in the selected image subset from red to green, which in turn can influence the reverse image search to search for images containing content with green color properties as opposed to content with red color properties. In other aspects, the user input may include a control to adjust other visual properties of the selected image subset, such as brightness and contrast. Similarly, search results derived from the reverse image search may be influenced based on the selected parameters of these visual properties.

In another embodiment, the processor 236 receives user input identifying multiple selected image subsets. In some aspects, the multiple selected image subsets correspond to the same input image (e.g., identifying different objects in the input image). In other aspects, the multiple selected image subsets correspond to different input images. In these aspects, the input images may be uploaded concurrently or subsequently via the user interface at the client 110. The multiple selected image subsets may be processed through the second part 502 to determine respective feature vectors. In this respect, the respective feature vectors may be averaged to determine a centroid vector identifying the dominant features among the feature vectors. In this respect, the reverse image search may be based on a comparison between the image feature vectors 505 and the centroid vector. The search results may represent two forms of images: (1) images containing content that resembles the selected image subsets being appended to one another; or (2) images containing content that resembles a merger between the selected image subsets. In the former, the content may be a composite of the identified objects (e.g., beach+palm tree=a scene with a beach and palm trees). In the latter, the content may be a blending of the identified objects (e.g., a mashup).

In one or more embodiments, the processor 236 using the image search engine 256 provides crop suggestions to a user. The input image may be processed to identify features corresponding to objects for predicting potential crop targets. The identified objects may represent potential locations on the input image where a user may likely select as a possible image subset. The processor 236 may determine coordinates of the potential crop locations relative to the input image, and associate the coordinates to a crop suggestion index. In this respect, the processor 236 may provide for display a representation of the identified object such that the crop suggestion index may be associated with the displayed object as a crop suggestion to the user. In turn, the processor 236 may receive user input identifying a selection of the crop suggestion via the user interface of the client 110. The image search engine using the selected crop suggestion may then perform a reverse image search to search for images containing content with similar features to those of the crop suggestion. In some aspects, the processor 236 may provide for display respective bounding boxes overlapping the input image to represent each of the crop suggestions. In these aspects, the user may select one of the bounding boxes to initiate the reverse image search. In one or more aspects, the processor 236 determines user information (e.g., user profile) associated with the user. The user information may identify usage data with respect to one or more historical image searches. The usage data may indicate that there is a high likelihood that the user may be interested in searching for at least one of the identified objects. In this respect, the crop suggestions may be generated based on the identified usage data.

In other embodiments, the processor 236 using the image search engine 256 provides search suggestions to a user. The user information such as a user profile may be used by the image search engine 256 to identify weighted contributors such as prioritization of keywords, geography, time of day associated with the image search, or the like. For example, the user data of the user may indicate that the user values certain styles of imagery more than others such that images associated with the keywords that the user values most may be prioritized to the top of the search results. In another example, the user may desire to find images pertaining to a certain geographical region. In these examples, the weighted contributors may serve as filters to influence the outcome of the search results. As such, the image search engine 256 can generate search suggestions that the user may find interesting.

Although many examples provided herein describe a user's information being identifiable, or usage data of users being stored, each user must grant explicit permission for such user information to be shared or stored. The explicit permission may be granted using privacy controls integrated into the disclosed system. Each user may be provided notice that such user information will be shared with explicit consent, and each user may at any time end having the information shared, and may delete any stored user information. The stored user information may be encrypted to protect user security.

FIGS. 6A-6D illustrate examples of a display including a user interface for selected image subset based search according to certain aspects of the subject technology. Specifically, FIG. 6A provides an example user interface 600 for initiating a reverse image search via an application 222 responsive to a cropped raw image serving as an image search query. FIG. 6B provides an example illustration of an input image 606a displayed in the user interface 600. FIG. 6C provides an example illustration of a cropping operation 606b with respect to the input image 606a displayed in the user interface 600. FIG. 6D provides an example illustration of the cropped raw image 606c displayed in the user interface 600 responsive to the cropping operation 606b.

In FIG. 6A, the user interface 600 includes a control section 601 and an output section 602. The user interface 600 includes a blank canvas 603 for receiving an input image and selecting a subset of the input image using one or more input tools (e.g., image upload control 604). Search results responsive to an image search query are provided for display via the output section 602. In some aspects, the control section 601 includes a search control (e.g., 605) to initiate the reverse image search. In other aspects, the reverse image search may be initiated independent of the search control 605. For example, the reverse image search may be initiated in response to receiving a selected image subset (see FIG. 6C).

In FIG. 6B, the input image 606a includes content that identifies multiple foreground objects resembling different types of fruit. In turn, the processor 236 using the image search engine 256 may provide for display the received input image (e.g., 606a) within the blank canvas 603. In some aspects, the processor 236 using the trained model (or the feature extraction module 517) may extract features of the input image 606a. In turn, the image search engine 256 using the trained model may predict that the user may be interested in searching for images containing a banana and/or a lemon based on the extracted features. In these aspects, the image search engine 256 may provide this predictive analysis as crop suggestions 607. In addition, the image search engine 256 may provide search suggestions 608 based on usage data of the user. For example, the search suggestions 608 may include possible search results based on filtering rules associated with certain image search patterns.

In FIG. 6C, the cropping operation 606b is applied to the input image 606a to determine a selected image subset. The cropped operation 606b may include a user selection using a bounding box that is adjustable in two dimensions for identifying the selected image subset. In this example, the bounding box is focusing on an object resembling a banana. The remaining portion of the input image 606a may be overlaid with a layer representing a non-selected area of the image. In this respect, the portion of the input image 606a bounded by the bounding box will be used to create the selected image subset. The processor 236 may determine the coordinates of the bounding box, and send the selected image subset to a storage service in order to obtain a source image that is an appropriately sized version of the input image 606a. Upon receipt of the source image, the processor 236 using the crop mapping module 515 can map the raw data bits of the source image which correspond to the coordinate of the bounding box to create the cropped raw image 606c (see FIG. 6D).

In FIG. 6D, the cropped raw image 606c may be provided for display within the blank canvas 603. In turn, the image search engine 256 identifies a listing of images 609 containing content that is visually similar to the cropped raw image 606c by filtering images in the extracted feature space. For example, the listing of images 609 includes images of bananas that are visually similar to the banana depicted in the cropped raw image 606c. In this embodiment, the search results may be provided for display within the output section 602 in real-time (or on-the-fly) based on an image comparison to the cropped raw image 606c using the image search engine 256. The listing of images 609 may be displayed in a particular order based on a prioritization of angle differences between compared feature vectors.

FIG. 7 is a block diagram illustrating an exemplary computer system 700 with which the client 110 and server 130 of FIG. 1 can be implemented. In certain aspects, the computer system 700 may be implemented using hardware or a combination of software and hardware, either in a dedicated server, or integrated into another entity, or distributed across multiple entities.

Computer system 700 (e.g., client 110 and server 130) includes a bus 708 or other communication mechanism for communicating information, and a processor 702 (e.g., processor 212 and 236) coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer readable medium for execution by, or to control the operation of, the computer system 700, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 (e.g., communications modules 218 and 238) include networking interface cards, such as Ethernet cards and modems. In certain aspects, the input/output module 710 is configured to connect to a plurality of devices, such as an input device 714 (e.g., input device 216) and/or an output device 716 (e.g., output device 214). Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 716 include display devices, such as a LCD (liquid crystal display) monitor, for displaying information to the user.

According to one aspect of the present disclosure, the client 110 and server 130 can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a PAN, a LAN, a CAN, a MAN, a WAN, a BBN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the images in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
receiving user input identifying a selection of at least a portion of a first image;
determining coordinates of the at least a portion of the first image;
obtaining a second image based on the selection, the second image being a raw image version of the first image;
generating a cropped image corresponding to at least a portion of the second image based on the determined coordinates;
initiating a reverse image search using the cropped image; and
generating search results associated with the reverse image search based on a comparison between the cropped image and a collection of images.

2. The computer-implemented method of claim 1, further comprising providing the first image for display, wherein the determined coordinates identify a two-dimensional bounding box relative to the displayed first image.

3. The computer-implemented method of claim 2, further comprising:
mapping pixel data of the second image which corresponds to the two-dimensional bounding box to generate the cropped image.

4. The computer-implemented method of claim 1, wherein obtaining the second image comprises:
providing a request for the second image to a storage service, the request identifying the at least a portion of the first image; and
receiving a response from the storage service based on the provided request, the second image being obtained via the received response.

5. The computer-implemented method of claim 4, wherein:
the request includes an identifier associated with the first image, and
at least a portion of the identifier identifies the second image.

6. The computer-implemented method of claim 1, wherein:
the obtained second image corresponds to one of a plurality of second image versions,
each of the plurality of second image versions corresponds to a different image size, and
the obtained second image being a best scaled size image available among the plurality of second image versions.

7. The computer-implemented method of claim 1, further comprising:
filtering the search results using metadata associated with one or more of the first image or the second image.

8. The computer-implemented method of claim 1, further comprising:
receiving the first image via a user interface on a client device, the first image identifying a representation of one or more objects; and
providing the first image for display in an input section of the user interface, the user input being received in response to the displayed first image.

9. A system comprising:
one or more processors; and
a computer-readable storage medium coupled to the one or more processors, the computer-readable storage medium including instructions that, when executed by the one or more processors, cause the one or more processors to:
receive a first user input comprising image data;
provide a representation of the image data for display;
receive a second user input comprising a user selection with respect to the displayed representation of the image data, the user selection identifying a first selected image subset of the image data, the first selected image subset representing a search query for initiating an image search;
determine a collection of images relevant to one or more features of the image data;
compare feature vectors of images in the collection of images to a feature vector of the first selected image subset; and
generate search results associated with the image search based on comparison results of the comparison between the feature vector of the first selected image subset and the feature vectors of the images.

10. The system of claim 9, wherein the instructions further cause the one or more processors to:
detect a representation of one or more objects in the image data;
determine a cropping suggestion based on the detected representation of the one or more objects; and
provide the cropping suggestion for display.

11. The system of claim 10, wherein the second user input is received in response to the displayed cropping suggestion, the user selection identifying a two-dimensional bounding box which corresponds to the cropping suggestion.

12. The system of claim 9, wherein the instructions further cause the one or more processors to:
detect a representation of one or more objects in the image data;
determine search suggestions based on the detected representation of the one or more objects, the search suggestions indicating one or more images respectively having content similar to the detected representation of the one or more objects; and
provide the determined search suggestions for display.

13. The system of claim 9, wherein the instructions further cause the one or more processors to:
determine user information associated with a user profile, the user information indicating usage behavior with respect to one or more historical image searches;
determine search suggestions based on the user information, the search suggestions indicating one or more images respectively having content similar to one or more selected image subsets included in the one or more historical image searches; and
provide the determined search suggestions for display.

14. The system of claim 9, wherein the instructions further cause the one or more processors to:
receive a third user input comprising a second user selection with respect to the displayed representation of the image data, the second user selection identifying a second selected image subset of the image data, the search results being generated based on a combination of the first selected image subset and the second selected image subset.

15. The system of claim 14, wherein the search results include images identifying respective representations of composite image data, the composite image data including content with one or more objects of the first selected image subset and one or more objects of the second selected image subset.

16. The system of claim 14, wherein the search results include images identifying respective representations of composite image data, the composite image data including content which is a mashup of one or more objects in the first selected image subset and one or more objects in the second selected image subset.

17. The system of claim 9, wherein the instructions further cause the one or more processors to:
detect watermark information in the image data; and
send a request to receive raw image data which is independent of the watermark information, the first selected image subset being selected from the raw image data via the user selection.

18. The system of claim 9, wherein the instructions further cause the one or more processors to:
initiate, in response to receiving the first user input, a user interface for cropping images, the user interface comprising one or more icons associated with respective controls to create a bounding box of varying dimensions, the user selection corresponding to dimensions of the bounding box; and
provide the user interface for display, the user interface being provided as an overlay overlapping the displayed representation of the image data.

19. The system of claim 9, wherein the instructions further cause the one or more processors to:
receive a text query associated with the second user input, the search results being generated based on a combination of the comparison results and the received text query.

20. A non-transitory computer readable storage medium coupled to a processor, the non-transitory computer readable storage medium including instructions that, when executed by the processor, cause the processor to:
provide a user interface for display via an application of a client device;
receive a first user input comprising first image data, the first image data identifying a representation of one or more objects;
provide a representation of the first image data for display in an input section of the user interface;
receive a second user input comprising a user selection associated with the displayed representation of the first image data, the user selection identifying selection of at least a portion of the displayed representation of the first image data within a two-dimensional bounding box;
determine coordinates of the two-dimensional bounding box relative to the displayed representation of the first image data;
provide a request to a storage service for second image data, the request identifying the user selection;
receive second image data from the storage service based on the user selection, the second image data being a raw image version of the first image data;
generate a first selected image subset of the second image data based on the determined coordinates, the first selected image subset corresponding to the selection of the at least a portion of the displayed representation of the first image data, the first selected image subset representing a search query for initiating an image search;
provide a representation of the first selected image subset for display in the input section;
extract a feature vector of the first selected image subset;
compare feature vectors of one or more images in a collection of images to the feature vector of the first selected image subset;
generate search results associated with the image search based on comparison results of the comparison between the feature vector of the first selected image subset and the feature vectors of the one or more images; and
provide for display the search results in an output section of the user interface.
